(19) United States
(12) Patent Application Publication
(10) Pub. No.: US 2025/0321111 A1
(43) Pub. Date: Oct. 16, 2025

(54) VOICE GUIDANCE DEVICE AND VOICE GUIDANCE METHOD

(71) Applicant: TOYOTA JIDOSHA KABUSHIKI KAISHA, Toyota-shi (JP)

(72) Inventors: Hideaki OTSUBO, Aichi-gun (JP); Tsutomu MIYAZAKI, Miyoshi-shi (JP); Yoshihiro ITO, Obu-shi (JP)

(73) Assignee: TOYOTA JIDOSHA KABUSHIKI KAISHA, Toyota-shi (JP)

(21) Appl. No.: 19/027,290

(22) Filed: Jan. 17, 2025

(30) Foreign Application Priority Data
Apr. 10, 2024 (JP) 2024-063480

(51) Int. Cl. G01C 21/36

(52) U.S. Cl. CPC G01C 21/3629

(57) ABSTRACT

The second memory of the voice guidance device stores a plurality of guidance information and a plurality of travel areas in association with each other. CPU of the voice guidance device adjusts the guidance mode of the guidance information associated with the second travel area when the vehicle is located in the second travel area of the plurality of travel areas, based on the execution state of the guidance of the guidance information associated with the first travel area of the plurality of travel areas.

### CROSS-REFERENCE TO RELATED APPLICATION

This application claims priority to Japanese Patent Application No. 2024-063480 filed on Apr. 10, 2024, incorporated herein by reference in its entirety.

### BACKGROUND

### 1. Technical Field

The present disclosure relates to a voice guidance device and a voice guidance method that guide guidance information to an occupant of a vehicle by voice.

### 2. Description of Related Art

Japanese Unexamined Patent Application Publication No. 2011-232097 (JP 2011-232097 A) discloses a navigation device as an example of a voice guidance device. The navigation device of JP 2011-232097 A is configured to enable linking with a traffic environment notification system installed on a road.

### SUMMARY

As a voice guidance device, there is a device that guides information not directly related to vehicle travel to an occupant by voice, the information not directly related to vehicle travel being information related to tourism, information related to a function of a vehicle or the like. In the voice guidance device, it is desirable to appropriately perform guidance of information by voice.

A voice guidance device for solving the problem is a device that guides predetermined guidance information to an occupant of a vehicle by voice.

The voice guidance device includes a processing circuit and a storage device. The storage device stores a plurality of guidance information and a plurality of travel areas in association with each other, the travel areas being where the vehicle travels. When the vehicle is positioned in a second travel area from among the travel areas, the processing circuit adjusts a state of guidance of the guidance information associated with the second travel area based on an execution state of guidance of the guidance information associated with a first travel area from among the travel areas.

A voice guidance method for solving the problem is a method that guides predetermined guidance information to an occupant of a vehicle by voice.

A plurality of guidance information and a plurality of travel areas are stored in association with each other in a storage device, the travel areas being where the vehicle travels. The voice guidance method, when the vehicle is positioned in a first travel area from among the travel areas, causes a processing circuit to execute outputting the guidance information to the occupant from a speaker under a condition in which an utterance condition of the guidance information associated with the first travel area is established, and when the vehicle reaches a second travel area from among the travel areas after the vehicle passes through the first travel area, causes the processing circuit to execute adjusting a state of guidance of the guidance information associated with the second travel area based on an execution state of guidance of the guidance information associated with the first travel area. Appropriateness of guidance of guidance information by voice is performed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle including a voice guidance device according to an embodiment;

FIG. 2 is a schematic diagram illustrating a state in which a road on which a vehicle travels is divided into a plurality of travel areas;

FIG. 3 is a diagram illustrating a table stored in a storage device included in the voice guidance device of FIG. 1;

FIG. 4 is a flow chart showing the first half of a series of processes performed by the processing circuitry of the voice guidance device of FIG. 1; and

FIG. 5 is a flowchart showing a second part of a series of processing executed by a processing circuit included in the voice guidance device of FIG. 1.

### DETAILED DESCRIPTION OF EMBODIMENTS

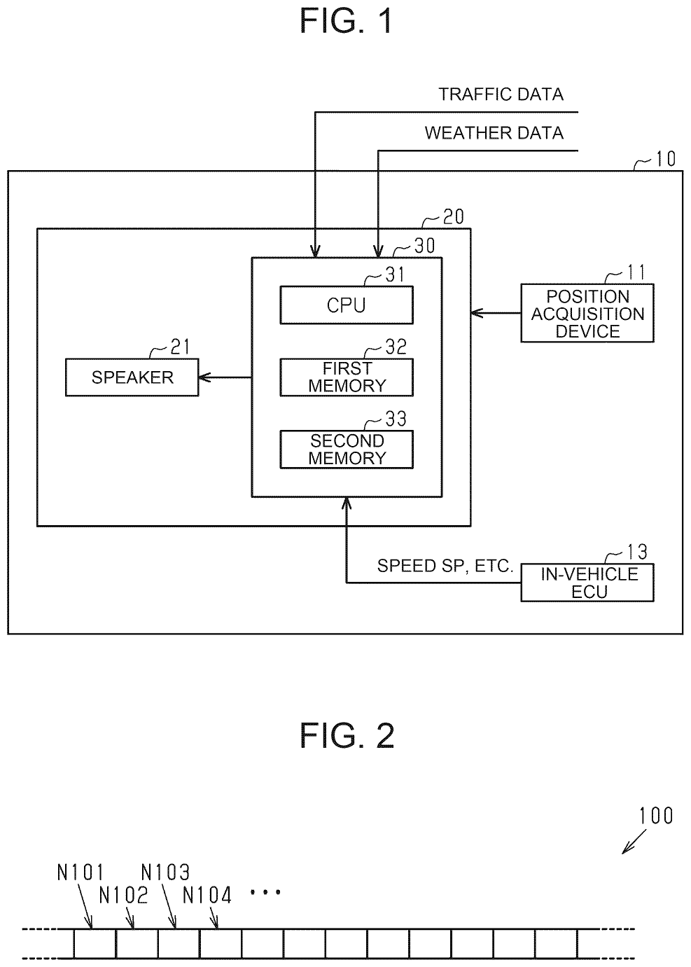

Hereinafter, an embodiment of a voice guidance device and a voice guidance method will be described with reference to FIG. 1 to FIG. 5.

FIG. 1 shows a vehicle 10 with a voice guidance device 20. The vehicle 10 includes a position acquisition device 11 and an electronic control device 13. Hereinafter, the electronic control device 13 mounted on the vehicle 10 is referred to as an “in-vehicle ECU 13”.

The position acquisition device 11 acquires the current position of the vehicle 10 by receiving radio waves transmitted from satellites outside the vehicle. The position acquisition device 11 transmits the acquired vehicle position data, which is data related to the current position of the vehicle 10, to the voice guidance device 20. An exemplary position acquisition device 11 is a GNSS. GNSS is an abbreviation for “Global Navigation Satellite System”.

The in-vehicle ECU 13 transmits traveling-related data, which is data related to the traveling condition of the vehicles 10, to the voice guidance device 20. For example, the in-vehicle ECU 13 transmits data related to the vehicle speed SP, which is the traveling speed of the vehicle 10, to the voice guidance device 20 as the traveling related data.

### Voice Guidance Device

The voice guidance device 20 guides the guidance information to the occupant of the vehicle 10 by voice. The voice guidance device 20 includes a speaker 21 and an electronic control device 30. Hereinafter, the electronic control device 30 included in the voice guidance device 20 is referred to as a “guidance ECU 30”.

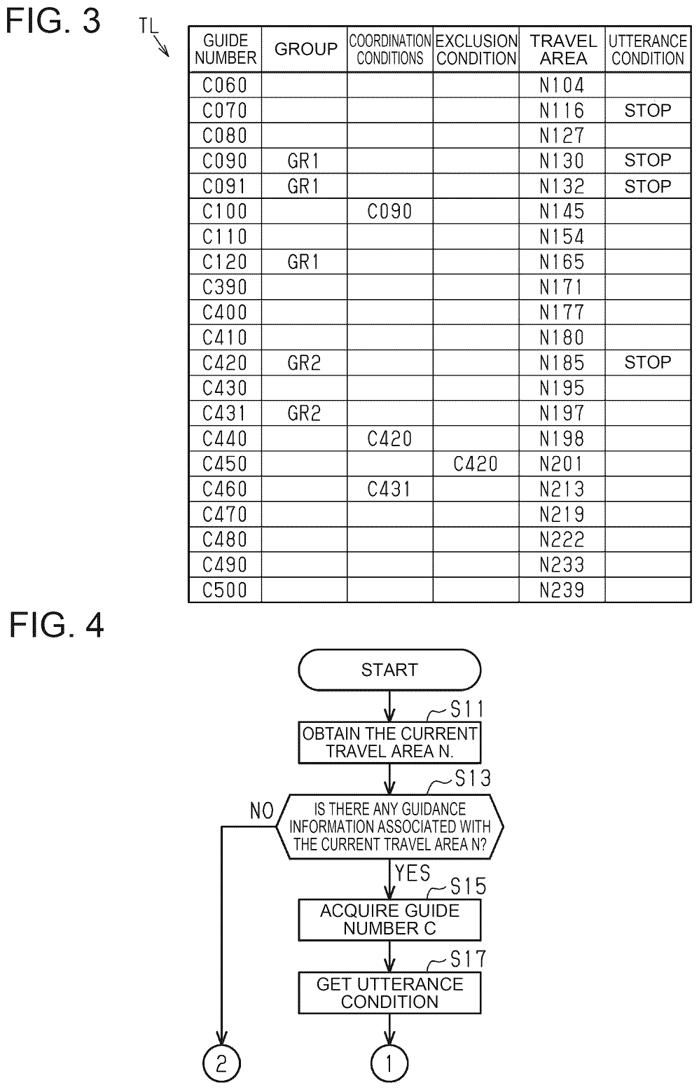

The guidance ECU 30 includes a CPU 31, a first memory 32, and a second memory 33. CPU 31 corresponds to the Processing Circuit. The first memories 32 store control programs executed by CPU 31. The second memory 33 stores a plurality of pieces of guidance information and a plurality of travel areas N in association with each other. For example, a table TL as shown in FIG. 3 is stored in the second memories 33. That is, the second memory 33 corresponds to the “storage device”. When CPU 31 executes the control program of the first memory 32 and CPU 31 refers to the table TL of the second memory 33, the guidance ECU 30 can voice-guide the guidance information to the occupant of the vehicle 10. “Guiding guidance information by voice” means “causing guidance information to be output from the speaker 21”.

The guidance ECU 30 is configured to be capable of acquiring traffic data and weather data in addition to the vehicle-position data and the travel-related data. Traffic data is data on road traffic. The weather data is data related to weather.

### Guidance Information

The guidance information guided by the voice guidance device 20 to the occupant by voice is information that is not directly related to the vehicle travel. The information directly related to the traveling of the vehicle includes, for example, information for guiding a route to a destination and information on an accident or a construction work on a road.

The guidance information may include, for example, information related to tourism and information that introduces the functions of the vehicle 10. The information on tourism includes, for example, information to introduce a tourist site and detailed information on a traveling route to the tourist site. The information introducing the function of the vehicle 10 includes information related to the operation of the switches provided in the vehicle 10 and information related to the effects obtained by the operation of the switches. The time required to guide such guidance information by voice is likely to be longer than the time required to guide information directly related to vehicle travel by voice.

### Travel Area

A plurality of travel areas N will be described with reference to FIG. 2.

The travel area N is an area in which the vehicle 10 travels. For example, as shown in FIG. 2, the roadway 100 on which the vehicles 10 travel is divided into a plurality of travel areas N101, N102, N103, N104, . . . .

The guidance ECU 30 can recognize the travel area N in which the vehicle 10 is traveling based on the vehicle position data received from the position acquisition device 11.

In the example illustrated in FIG. 2, the travel area N is set continuously, but the present disclosure is not limited thereto. That is, the plurality of travel areas N may not be continuous with each other. For example, the travel area N102 may be set at a position away from the travel area N101 and the travel area N103.

### Table

Referring to FIG. 3, the table TL stored in the second memories 33 will be described.

In the table TL, the guide number C and the travel area N are associated with each other. The guide number C is a number assigned to each guidance information. For example, the travel area N104 among the plurality of travel areas N is associated with the guidance information to which the guide number C060 is attached. This means that when the vehicles 10 are located in the travel area N104, the guidance information with the guide number C060 can be audibly guided to the occupant.

Among the plurality of guidance information, there is guidance information in which an utterance condition is set. The utterance condition is one of conditions for allowing guidance of guidance information. In the embodiment illustrated in FIG. 3, an utterance condition is not set in the guidance information to which the guide number C060 is attached. On the other hand, an utterance condition is set in the guidance information to which the guide number C070 is attached. When the vehicle 10 is located in the travel area N104, the guidance information to which the guide number C060 is attached is audibly guided to the occupant. When the vehicle 10 is located in the travel area N116, the guidance information with the guide number C070 is audibly guided to the occupant on condition that the utterance condition is satisfied. On the other hand, if the utterance condition is not satisfied even if the vehicles 10 are located in the travel area N116, the guidance information with the guide number C070 is not audibly guided to the occupant.

In the example illustrated in FIG. 3, the utterance condition is that the vehicle 10 is stopped. That is, when the vehicles 10 are stopped N116 the travel area, the guidance information to which the guide number C070 is attached is audibly guided to the occupant. On the other hand, when the vehicle 10 is not stopped N116 the travel area, the guidance information with the guide number C070 is not audibly guided to the occupant.

In the table TL illustrated in FIG. 3, there is a guide number C in which the column of the utterance condition is blank, for example, guidance information to which a guide number C060 is attached. The guidance information to which the guide number C is attached corresponds to the guidance information for which the utterance condition is not set. If another condition is satisfied, the guidance information for which the utterance condition is not set is guided to the occupant by voice. For example, when the vehicle 10 is located in the travel area N104, guidance with a guide number C060 is permitted to guide guidance information even if the vehicle 10 is not stopped.

Among the plurality of guidance information, there is guidance information in which a prerequisite is set. The prerequisite indicates that there is information that is a prerequisite for guiding the guidance information. In the present embodiment, the precondition includes a coordination condition and an exclusion condition. When the collaboration condition is set, the guidance information is permitted to be guided on condition that the guidance information which is a prerequisite for guiding the guidance information is guided. On the other hand, when the exclusive condition is set, the guidance information is permitted to be guided on condition that the guidance information as a prerequisite is not guided when the guidance information is guided. In the following description, the “prerequisite guidance information” may be referred to as “pre-proposal information”.

In the embodiment illustrated in FIG. 3, a prerequisite is set for each of the guidance information to which the guide number C100, C440, C450, C460 is attached. In the guidance information to which the guide number C100 is attached, the coordination condition is set, while the exclusive condition is not set. The coordination condition of the guidance information to which the guide number C100 is attached is that the guidance information to which the guide number C090 is attached is guided to the occupant. In such cases, the guidance information to which the guide number C090 is attached corresponds to the information in the previous proposal. Therefore, when the vehicle 10 reaches the travel area N145 after the guidance information to which the guide number C090 is attached is guided to the occupant, it is permitted to guide the guidance information to which the guide number C100 is attached to the occupant. On the other hand, when the guidance information with the guide number C090 is not guided to the occupant and the vehicle 10 reaches the travel area N145, it is not permitted to guide the guidance information with the guide number C100 to the occupant.

For each of the guidance information to which the guide number C440, C460 is attached, the coordination condition is set, while the exclusive condition is not set. On the other hand, in the guidance information to which the guide number C450 is attached, the exclusive condition is set, while the cooperative condition is not set. The exclusion condition of the guidance information to which the guide number C450 is attached is that the guidance information to which the guide number C420 is attached is guided to the occupant. In such cases, the guidance information to which the guide number C420 is attached corresponds to the information in the previous proposal. Therefore, when the vehicle 10 reaches the travel area N201 after the guidance information to which the guide number C420 is attached is guided to the occupant, it is not permitted to guide the guidance information to which the guide number C450 is attached to the occupant. On the other hand, when the guidance information to which the guide number C420 is attached is not guided to the occupant and the vehicle 10 reaches the travel area N201, it is permitted to guide the guidance information to which the guide number C450 is attached to the occupant.

Some of the guidance information is grouped. For example, each of the guidance information to which the guide number C090, C091, C120 is attached is included in the first group GR1. Only one piece of guidance information of the plurality of pieces of guidance information included in the first group GR1 may be audibly guided to the occupant. That is, when the guidance information to which the guide number C090 is attached is guided out of the plurality of guidance information, for example, the guidance information to which the other guide number C091, C120 is attached is not guided to the occupant.

Each of the guidance information to which the guide number C420, C431 is attached is included in the second group GR2. In other words, only one piece of guidance information of the plurality of pieces of guidance information included in the second group GR2 may be audibly guided to the occupant.

### A Series of Processes for Audio Guidance of Guidance Information

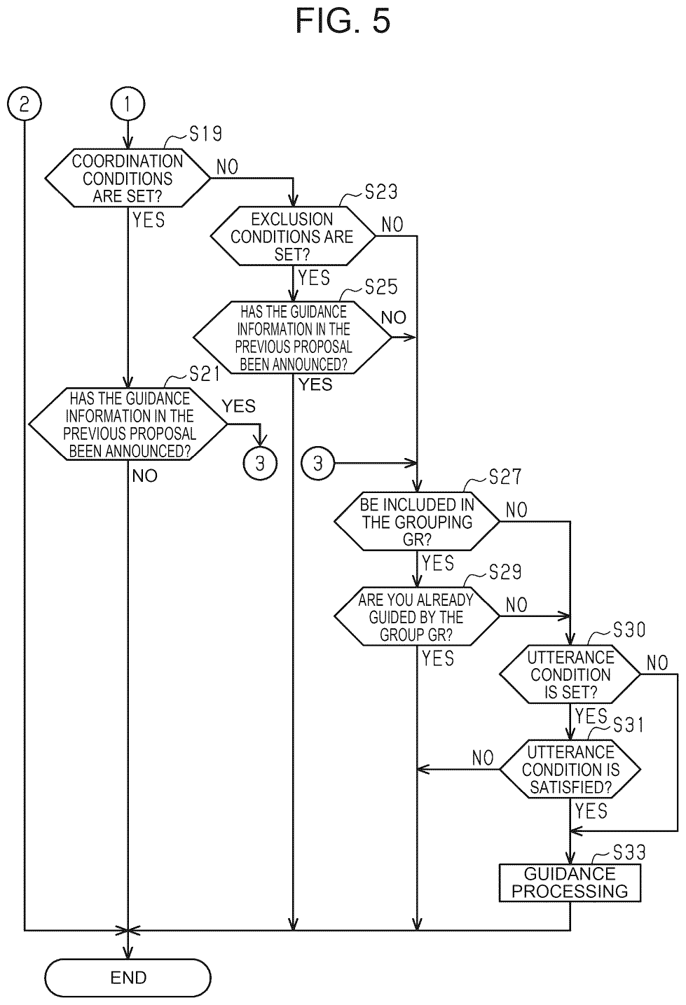

Referring to FIG. 4 and FIG. 5, a series of processes executed by CPU 31 when the guidance information is audibly guided to the occupant will be described. CPU 31 repeatedly executes the series of processes at predetermined control cycles.

In S11, CPU 31 acquires the current travel area N in which the vehicle 10 is located, based on the current position of the vehicle 10 indicated by the vehicle position data. In a subsequent S13, CPU 31 determines whether the table TL stored in the second memories 33 contains guidance information associated with the current travel area N. When CPU 31 determines that the guidance information associated with the current travel area N is in the table TL (S13: YES), the process proceeds to S15. When it is determined that the guidance information associated with the travel area N is not in the table TL (S13: NO), CPU 31 temporarily ends the series of processes.

In S15, CPU 31 refers to the table TL to obtain the guide number C attached to the guidance information associated with the current travel area N. In the following S17, CPU 31 refers to the table TL to acquire the utterance condition of the guide number C acquired by S15.

In the following S19, CPU 31 refers to the table TL to determine whether or not the coordination criteria are set in the guidance information to which the guide number C acquired by S15 is attached. If CPU 31 determines that the coordination criterion is set (S19: YES), the process proceeds to S21. When CPU 31 determines that the coordination condition is not set (S19: NO), the process proceeds to S23.

In S21, CPU 31 determines whether or not the information in the pre-proposal for the guidance information to which the guide number C acquired by S15 is attached has been guided to the occupant. When CPU 31 determines that the guidance information has been guided (S21: YES), the process proceeds to S27. When CPU 31 determines that the guidance information has not been guided (S21: NO), the series of processes is temporarily ended.

In S23, CPU 31 refers to the table TL to determine whether or not an exclusion condition is set in the guidance information to which the guide number C acquired by S15 is attached. When CPU 31 determines that the exclusive condition is set (S23: YES), the process proceeds to S25. When CPU 31 determines that the exclusive condition is not set (S23: NO), the process proceeds to S27.

In S25, CPU 31 determines whether or not the information in the pre-proposal for the guidance information to which the guide number C acquired by S15 is attached has been guided to the occupant. When CPU 31 determines that the guidance information has been guided (S25: YES), the series of processes is temporarily ended. When CPU 31 determines that the guidance information is not guided (S25: NO), the process proceeds to S27.

In S27, CPU 31 refers to the table TL and determines whether or not the guidance information to which the guide number C acquired by S15 is attached is included in any one of the plurality of group GR. When CPU 31 determines that the guidance information is included in any one of the plurality of group GR (S27: YES), the process proceeds to S29. When CPU 31 determines that the guidance information is not included in any of the plurality of group GR (S27: NO), the process proceeds to S30.

In S29, CPU 31 determines whether or not any guidance information has been guided in the group GR including the guidance information to which the guide number C acquired by S15 is attached. When it is determined that any one of the plurality of pieces of guidance information included in the group GR has been guided (S29: YES), CPU 31 temporarily ends the series of processes. When CPU 31 determines that none of the plurality of pieces of guidance information included in the group GR is guided (S29: NO), the process proceeds to S30.

In S30, CPU 31 determines whether an utterance condition is set for the guidance information to which the guide number C acquired by S15 is attached. When CPU 31 determines that the utterance condition is set (S30: YES), the process proceeds to S31. When CPU 31 determines that the utterance condition is not set (S30: NO), the process proceeds to S33.

In S31, CPU 31 determines whether or not an utterance condition of the guidance information to which the guide number C acquired by S15 is attached is satisfied. In the present embodiment, CPU 31 determines whether or not the vehicle is stopped based on the vehicle speed SP acquired from the in-vehicle ECU 13. When determining that the vehicle is stopped, CPU 31 determines that the utterance condition is satisfied (S31: YES). CPU 31 then transitions the process to S33. If it is determined that the vehicle is not stopped, CPU 31 determines that the utterance condition is not satisfied (S31: NO). Then, CPU 31 ends the series of processes once.

In S33, CPU 31 executes a guidance process of guiding the occupant with the guidance information to which the guide number C acquired by S15 is attached by sound. In the guidance process, CPU 31 outputs guidance information from the speaker 21. CPU 31 ends the series of processes once the guidance of the guidance information is completed.

### Voice Guidance Method

The voice guidance method of the present embodiment includes a plurality of processes illustrated in FIG. 4 and FIG. 5.

In the voice guidance method, when the vehicle 10 is located in the first travel area among the plurality of travel areas N, CPU 31 determines whether or not the utterance condition of the guidance information associated with the first travel area is satisfied (S31). Then, in the voice guidance method, CPU 31 causes the occupant to output the guidance information associated with the first travel area from the speaker 21 on the condition that the utterance condition is satisfied (S31: YES) (S33).

After the vehicle 10 passes through the first travel area, the vehicle 10 may reach the second travel area among the plurality of travel areas N. In this case, the voice guidance method causes CPU 31 to adjust the guidance mode of the guidance information associated with the second travel area based on the guidance mode of the guidance information associated with the first travel area.

A case where the coordination condition is set in the guidance information associated with the second travel area will be described. It is assumed that the coordination condition is that the guidance information associated with the first travel area is guided. In this case, in the voice guidance method, CPU 31 determines that the coordination condition is set for the guidance information associated with the second travel area (S19: YES). There is a S21: YES where the guidance information associated with the first travel area has been guided. In this case, in the voice guidance method, CPU 31 causes the occupant to output the guidance information associated with the second travel area from the speaker 21 on the condition that the utterance condition is satisfied (S31: YES) (S33). When the guidance information associated with the first travel area is not guided (S21: NO), CPU 31 does not cause the guidance information associated with the second travel area to be outputted from the speaker 21.

A case where the exclusion condition is set in the guidance information associated with the second travel area will be described. It is assumed that the exclusion condition is that the guidance information associated with the first travel area is guided. In this case, in the voice guidance method, CPU 31 determines that an exclusion condition is set for the guidance information associated with the second travel area (S23: YES). There is a S25: NO where the guidance information associated with the first travel area is not guided. In this case, in the voice guidance method, CPU 31 causes the occupant to output the guidance information associated with the second travel area from the speaker 21 on the condition that the utterance condition is satisfied (S31: YES) (S33). When the guidance information associated with the first travel area has been guided (S25: YES), CPU 31 does not cause the guidance information associated with the second travel area to be outputted from the speaker 21.

A case where the guidance information associated with the first travel area and the guidance information associated with the second travel area are grouped will be described. The group including the guidance information associated with the first travel area and the guidance information associated with the second travel area is referred to as “predetermined group GRN”. In this case, in the voice guidance method, CPU 31 is caused to determine the guidance mode of the remaining guidance information among the plurality of pieces of guidance information based on the guidance mode of one piece of guidance information among the plurality of pieces of guidance information included in the predetermined group GRN. For example, the guidance information associated with the second travel area may be included in a predetermined group GRN of the plurality of group GR (S27: YES). In this case, in the voice guidance method, CPU 31 determines whether or not one piece of guidance information of the plurality of pieces of guidance information included in the predetermined group GRN has been guided (S29). When one piece of guidance information of the plurality of pieces of guidance information included in the predetermined group GRN has been guided (S29: YES), CPU 31 does not cause the guidance information associated with the second travel area to be outputted from the speaker 21. There is a S29: NO where none of the plurality of pieces of guidance information included in the predetermined group GRN is guided. In this case, on the condition that the utterance condition is satisfied (S31: YES), CPU 31 causes the occupant to output the guidance information associated with the second travel area from the speaker 21 (S33).

### Operation and Effect of the Present Embodiment

(1) CPU 31 adjusts the guidance mode of the guidance information associated with the second travel area when the vehicle 10 is located in the second travel area based on the guidance execution state of the guidance information associated with the first travel area among the plurality of travel areas N. Here, the guidance information associated with the first travel area is referred to as “first guidance information”. The guidance information associated with the second travel area is referred to as “second guidance information”.

Here, it is assumed that the second guidance information is information on the assumption that the first guidance information is guided to the occupant. Consider a comparative example in which the first guidance information is not guided to the occupant when the vehicle 10 is positioned in the first travel area, and the second guidance information is guided to the occupant when the vehicle 10 reaches the second travel area. In this comparative example, even if the second guidance information is guided to the occupant who does not know the content of the first guidance information, the occupant who is the listener cannot understand the content of the second guidance information, and there is a possibility that the occupant may feel distrust with respect to the voice guidance service using the voice guidance device.

In this regard, in the voice guidance device 20 of the present embodiment, the guidance mode of the second guidance information is adjusted according to the execution mode of the guidance of the first guidance information. That is, the voice guidance device 20 may generate a causal relationship between the guidance mode of the second guidance information and the guidance execution mode of the first guidance information. As a result, the voice guidance device 20 can appropriately guide the information in the voice.

(2) As described above, the time required for guiding the guidance information is relatively long. The longer the time required for the guidance, the more the attention of the driver who is the listener tends to decrease. In the voice guidance device 20 of the present embodiment, when it can be determined that there is a possibility that the occupant holds the discomfort as described above, it is possible to prevent the guidance of the second guidance information. Therefore, the voice guidance device 20 can appropriately guide the information in the voice while suppressing the decrease in the driver's attention.

(3) It is set that the vehicle 10 is stopped as the utterance condition of a part of the guidance information among the plurality of guidance information. CPU 31 audibly guides guidance information to the occupant of the vehicle 10, provided that the vehicle is stopped. As a result, the voice guidance device 20 guides the guidance information to the occupant when the vehicle 10 is stopped, thereby suppressing a decrease in the driver's attention caused by the guidance information.

(4) The plurality of guidance information includes information of the same content. When the guidance information of the same content is guided to the occupant many times, the occupant may feel uncomfortable with respect to the voice guidance service using the voice guidance device.

In this regard, CPU 31 of the voice guidance device 20 of the present embodiment determines the guidance mode of the remaining guidance information among the plurality of pieces of guidance information based on the execution state of the guidance of one of the plurality of pieces of guidance information included in a certain group. For example, when CPU 31 guides the occupant with the guidance information of one of the plurality of pieces of guidance information included in a certain group, it does not guide the occupant with the remaining guidance information. That is, the voice guidance device 20 can suppress guidance information of the same content from being guided many times.

### Example of Change

The above-described embodiment can be modified as follows. The above-described embodiments and the following modifications can be implemented in combination with each other as long as they are not technically contradictory.
The utterance condition may include a condition other than that the vehicle 10 is stopped. For example, the utterance condition may include at least one of the following conditions.
(A1) The day of the week on which the vehicle 10 travels is a predetermined day of the week.
(A2) The time period in which the vehicle 10 travels is a predetermined time period.
(A3) The weather shall be the specified weather. The “predetermined weather” refers to sunny weather or rain.
(A4) The lane on which the vehicle 10 travels is a predetermined lane. The “predetermined lane” refers to a traveling lane or an overtaking lane.
(A5) Vehicle speed SP shall be within the specified speed range. (A6) The duration of travel of the vehicle 10 is equal to or longer than a predetermined time. (A7) The number of occupants of the vehicle 10 is equal to or greater than a predetermined number. Or, the number of passengers shall be equal to or less than the predetermined number.

For example, when (A1) is set as the utterance condition, CPU 31 can adjust the guidance information to the occupant according to the day of the week. For example, when (A2) is set as the utterance condition, CPU 31 can adjust the guidance mode of the guidance information to the occupant according to the time-zone.

Note that the utterance condition may include a condition other than a condition that can determine whether or not the utterance condition is satisfied based on information based on a detection result of the sensor and information received through communication. For example, the utterance condition may include a condition that can determine whether or not the utterance condition is satisfied based on information obtained by an operation of the terminal by the occupant.
The voice guidance device may set an utterance condition according to a configuration of an occupant riding on the vehicle 10, a physical condition of the occupant, and the like.
The voice guidance device 20 does not necessarily group some guidance information among the plurality of guidance information.
Two or more pieces of guidance information may be prepared as guidance information associated with the second travel area. In this case, when the vehicle 10 is located in the second travel area, CPU 31 may select and guide the guidance information to be guided to the occupant based on whether or not the guidance information associated with the first travel area is guided to the occupant.
The voice guidance device 20 may be an in-vehicle device, or may be a device brought into the vehicle by an occupant of the vehicle 10. When the voice guidance device 20 is an in-vehicle device, the navigation device may function as the voice guidance device 20.
The information terminal owned by the occupant of the vehicle 10 may function as the voice guidance device 20. Examples of the information terminal include a smartphone and a tablet terminal. In this case, the processing circuits of the information terminals are caused to execute a plurality of processes constituting the voice guidance method.
The guidance ECU 30 may be configured to include a plurality of processing circuit. In this case, among the plurality of processes constituting the voice guidance method, a part of the processes may be executed by the first processing circuit among the plurality of processing circuits, and other processes other than the part of the processes may be executed by the second processing circuit among the plurality of processing circuits.
The guidance ECU 30 includes a CPU and a ROM, and is not limited to executing a software-process. That is, the guidance ECU 30 may have any of the following configurations (a), (b), and (c).

(a) The guidance ECU 30 includes one or more processors that execute various processes in accordance with a computer program. The processor includes CPU and memories such as RAM and ROM. The memory stores a program code or a command configured to cause the CPU to execute the process. Memory, or computer readable media, includes any available media that can be accessed by a general purpose or special purpose computer.

(b) The guidance ECU 30 includes one or more dedicated hardware circuitry for performing various processes. Dedicated hardware circuits may include, for example, application-specific integrated circuits, i.e., ASIC or FPGA. Note that ASIC is an abbreviation of “Application Specific Integrated Circuit”, and FPGA is an abbreviation of “Field Programmable Gate Array”.

(c) The guidance ECU 30 includes one or more processors that execute some of the various processes in accordance with a computer program, and one or more hardware circuitry dedicated to executing the remaining processes of the various processes.

It should be noted that the expression “at least one” as used herein means “one or more” of the desired options. As an example, the expression “at least one” as used herein means “only one option” or “both of two options” if the number of options is two. As another example, the expression “at least one” as used herein means “only one option” or “any combination of two or more options” if the number of options is three or more.

What is claimed is:

1. A voice guidance device that guides predetermined guidance information to an occupant of a vehicle by voice, the voice guidance device comprising a processing circuit and a storage device, wherein:
the storage device stores a plurality of guidance information and a plurality of travel areas in association with each other, the travel areas being where the vehicle travels; and
when the vehicle is positioned in a second travel area from among the travel areas, the processing circuit adjusts a state of guidance of the guidance information associated with the second travel area based on an execution state of guidance of the guidance information associated with a first travel area from among the travel areas.

2. The voice guidance device according to claim 1, wherein:
the storage device stores an utterance condition for each of the guidance information, the utterance condition being a condition of whether or not to execute voice guidance of the guidance information;
the utterance condition of the guidance information associated with the first travel area includes the vehicle being stopped;
when the vehicle is positioned in the first travel area, the processing circuit guides the guidance information associated with the first travel area by voice under a condition in which the vehicle is stopped in the first travel area; and
when the vehicle is positioned in the second travel area, the processing circuit determines whether or not to guide the guidance information associated with the second travel area to the occupant based on whether or not the guidance information associated with the first travel area has been guided to the occupant.

3. The voice guidance device according to claim 1, wherein:
a part of guidance information from among the guidance information stored in the storage device is grouped; and
the processing circuit determines a state of guidance of remaining guidance information from among the guidance information based on an execution state of guidance of one part of the guidance information from among the grouped part of guidance information.

4. A voice guidance method that guides predetermined guidance information to an occupant of a vehicle by voice, the voice guidance method
causes a storage device to execute storing a plurality of guidance information and a plurality of travel areas in association with each other, the travel areas being where the vehicle travels, and
when the vehicle is positioned in a first travel area from among the travel areas, causes a processing circuit to execute outputting the guidance information to the occupant from a speaker under a condition in which an utterance condition of the guidance information associated with the first travel area is established, and
when the vehicle reaches a second travel area from among the travel areas after the vehicle passes through the first travel area, causes the processing circuit to execute adjusting a state of guidance of the guidance information associated with the second travel area based on an execution state of guidance of the guidance information associated with the first travel area.
